(19) United States
(12) Patent Application Publication
(10) Pub. No.: US 2017/0286397 A1
(43) Pub. Date: Oct. 5, 2017

(54) Predictive Embeddings

(71) Applicant: International Business Machines Corporation, Armonk, NY (US)

(72) Inventor: Daniel P. Gonzalez, Denver, CO (US)

(21) Appl. No.: 15/085,973

(22) Filed: Mar. 30, 2016

(51) Int. Cl. G06F 17/27

(52) U.S. Cl. CPC G06F 17/279; G06F 17/271; G06F 17/278

(57) ABSTRACT

An approach is provided in which an information handling system detects an unknown word in a sentence and generates a context embedding using known words in proximity to the unknown word in the sentence. Next, the information handling system creates a predictive embedding of to the unknown word based upon the context embedding. The predictive embedding corresponds to an embedding area of the unknown word without specifying the unknown word. In turn, the information handling system utilizes the predictive embedding to generate natural language processing results corresponding to the sentence.

### BACKGROUND

The present disclosure relates to training a predictive embedding model and using the predictive embedding model to replace an unknown word with a predictive embedding that describes a distributed representation of the unknown word.

“Word embedding” is a collective term for a set of language modeling and feature learning techniques in natural language processing in which words or phrases from a vocabulary are mapped to real number vectors based on their meaning, word usage, and context relative to other words in the vocabulary. In turn, words with similar meanings have similar vectors and are in proximity to each another in embedding space. Approaches to generate this mapping include neural networks, dimensionality reduction on a word co-occurrence matrix, and explicit representation in terms of the context in which words appear. Word and phrase embeddings, when used as an underlying input representation, have been shown to boost performance of natural language processing tasks such as syntactic parsing and sentiment analysis.

Some of today's technologies use a group of related models to produce word embeddings. These models are typically shallow, two-layer neural networks, which are trained to reconstruct linguistic contexts of words such as determining “king” is to “queen” as “man” is to “woman” when each of the words exists in a dictionary.

### BRIEF SUMMARY

According to one embodiment of the present disclosure, an approach is provided in which an information handling system detects an unknown word in a sentence and generates a context embedding using known words in proximity to the unknown word in the sentence. Next, the information handling system creates a predictive embedding of to the unknown word based upon the context embedding. The predictive embedding corresponds to an embedding area of the unknown word without specifying the unknown word. In turn, the information handling system utilizes the predictive embedding to generate natural language processing results corresponding to the sentence.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment.

FIG. 3 is a diagram depicting a knowledge manager that trains a predictive embedding model and subsequently utilizes the predictive embedding model to generate predictive embeddings corresponding to unknown words in a sentence;

FIG. 4 is a flowchart depicting steps take to train a predictive embedding model;

FIG. 5 is a diagram showing a training sentence transformed to a training context embedding and input into a predictive embedding model for training;

FIG. 6 is a flowchart showing steps taken to generate a predictive embedding for an unknown word and using the predictive embedding in natural language post-processing tasks;

FIG. 7 is a diagram depicting a runtime system generating a predictive embedding of an unknown word detected in a runtime sentence; and

FIG. 8 is a diagram depicting an embedding space that maps feature sets of words based on their meanings.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

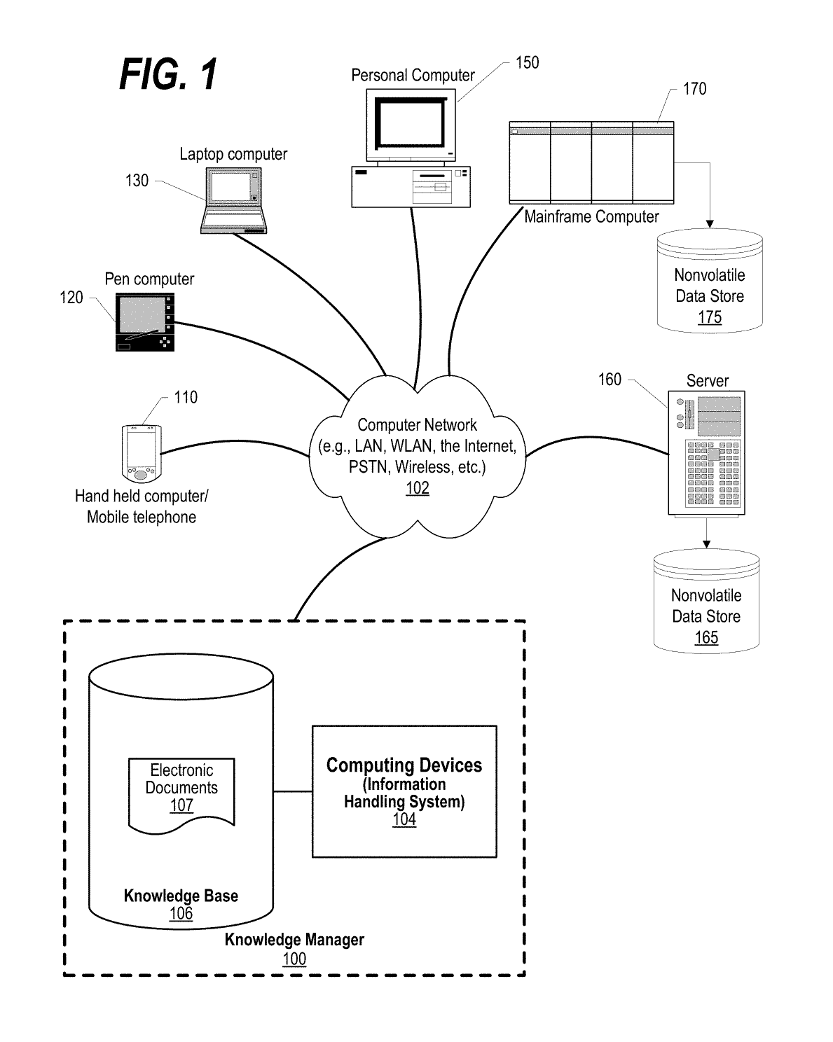

FIG. 1 depicts a schematic diagram of one illustrative embodiment of a question/answer (QA) system knowledge manager 100 in a computer network 102. Knowledge manager 100 may include a computing device 104 (comprising one or more processors and one or more memories, and potentially any other computing device elements generally known in the art including buses, storage devices, communication interfaces, and the like) connected to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. Knowledge manager 100 and network 102 may enable question/answer (QA) generation functionality for one or more content users. Other embodiments of knowledge manager 100 may be used with components, systems, sub-systems, and/or devices other than those that are depicted herein.

Knowledge manager 100 may be configured to receive inputs from various sources. For example, knowledge manager 100 may receive input from the network 102, a corpus of electronic documents 107 or other data, a content creator 108, content users, and other possible sources of input. In one embodiment, some or all of the inputs to knowledge manager 100 may be routed through the network 102. The various computing devices 104 on the network 102 may include access points for content creators and content users. Some of the computing devices 104 may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured resource sources. In this manner, some processes populate the knowledge manager with the knowledge manager also including input interfaces to receive knowledge requests and respond accordingly.

In one embodiment, the content creator creates content in a document 107 for use as part of a corpus of data with knowledge manager 100. The document 107 may include any file, text, article, or source of data for use in knowledge manager 100. Content users may access knowledge manager 100 via a network connection or an Internet connection to the network 102, and may input questions to knowledge manager 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager. Knowledge manager 100 may interpret the question and provide a response to the content user containing one or more answers to the question. In some embodiments, knowledge manager 100 may provide a response to users in a ranked list of answers.

In some illustrative embodiments, knowledge manager 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

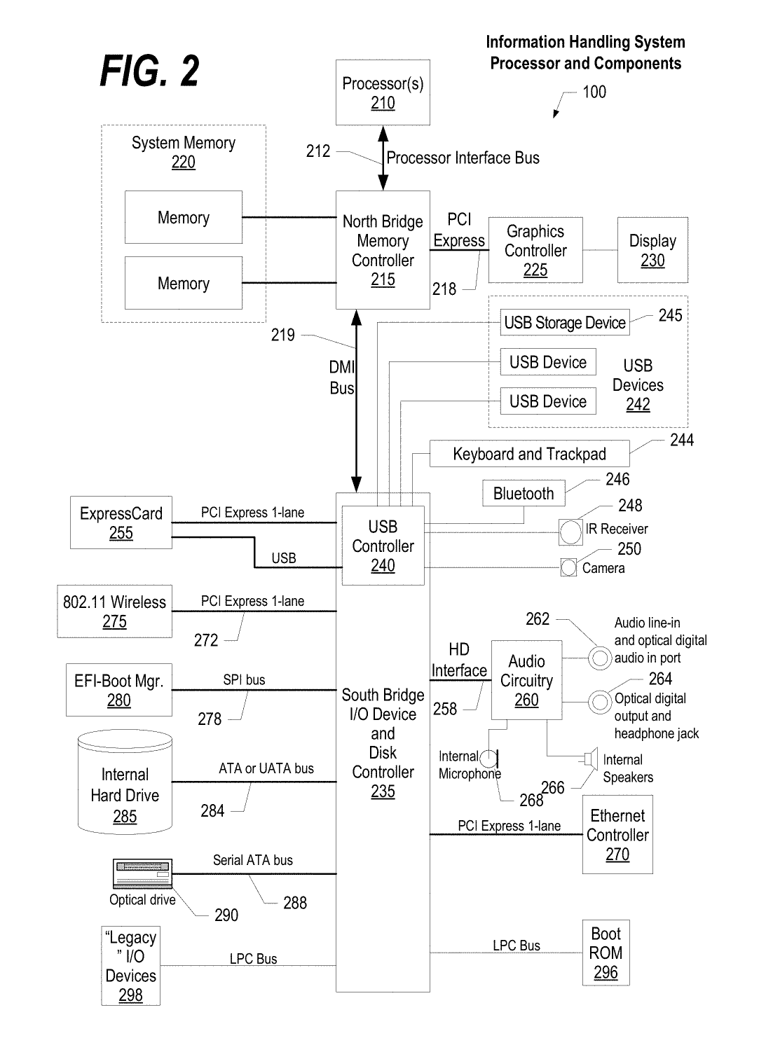

Types of information handling systems that can utilize knowledge manager 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 100. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 0.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

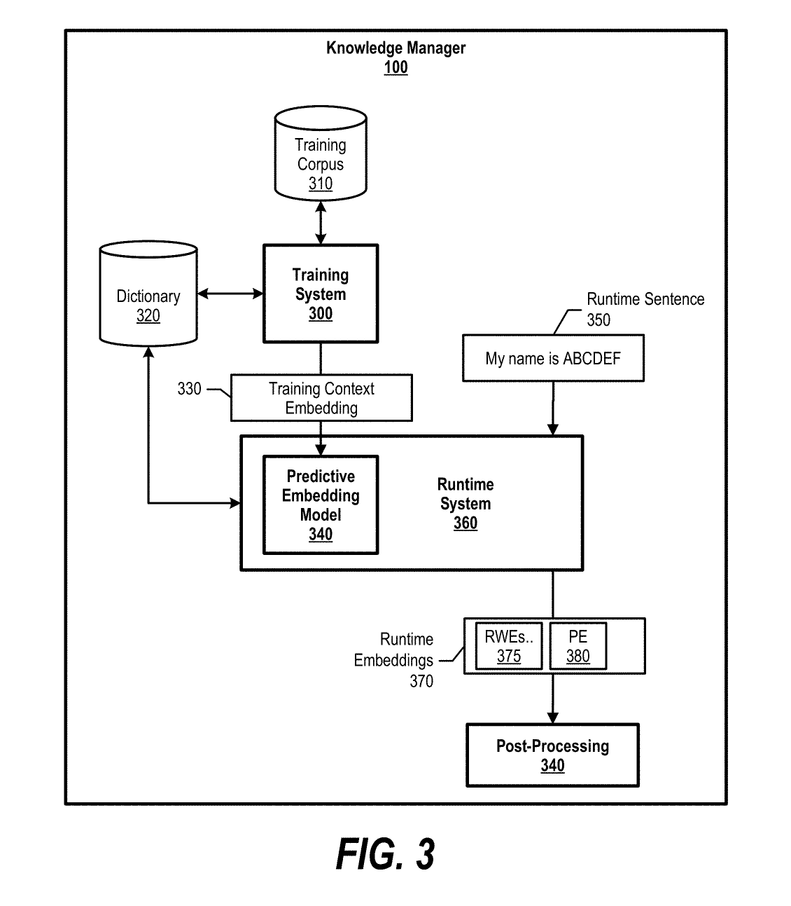

FIGS. 3 through 7 depict an approach that can be executed on an information handling system. The information handling system trains a predictive embedding model and uses the predictive embedding model to replace an unknown word with a predictive embedding that describes a distributed representation of the unknown word.

During the predictive embedding model training process, the information handling system randomly selects a word from a training sentence and builds a training context using words in proximity to the randomly selected word. Next, the information handling system retrieves word embeddings (numerical representations) corresponding to the words in the training context and concatenates the word embeddings into a “training context embedding.” The information handling system feeds the training context embedding into the predictive embedding model that, in turn, trains a linear projection of the predictive embedding model. The information handling system repeats the steps described above until the predictive embedding model is adequately trained.

After the training process, the information handling system uses the predictive embedding model in a runtime environment to generate predictive embeddings of unknown words detected in a sentence. The information handling system first generates a runtime context from known words in proximity to the unknown word in the sentence. Next, the information handling system retrieves word embeddings corresponding to the known words in the runtime context and concatenates the word embeddings into a “runtime context embedding.” The information handling system feeds the runtime context embedding into the predictive embedding model, which produces a predictive embedding of the unknown word as an output. In turn, the information handling system uses the predictive embedding to generate natural language processing results based on post-processing tasks such as sentiment analysis, syntactic parsing, named entity recognition, etc.

FIG. 3 is a diagram depicting a knowledge manager that trains a predictive embedding model and subsequently utilizes the predictive embedding model to generate predictive embeddings corresponding to unknown words in a sentence.

Knowledge manager 100 includes training system 300, which trains predictive embedding model 340 using training context embeddings 330. Training system 300 begins by randomly initializing numeric word embeddings (e.g., vectors) of words in dictionary 320. For example, word embeddings dictionary 320 may include 100,000 words and training system 300 assigns random embedding values to each of the words.

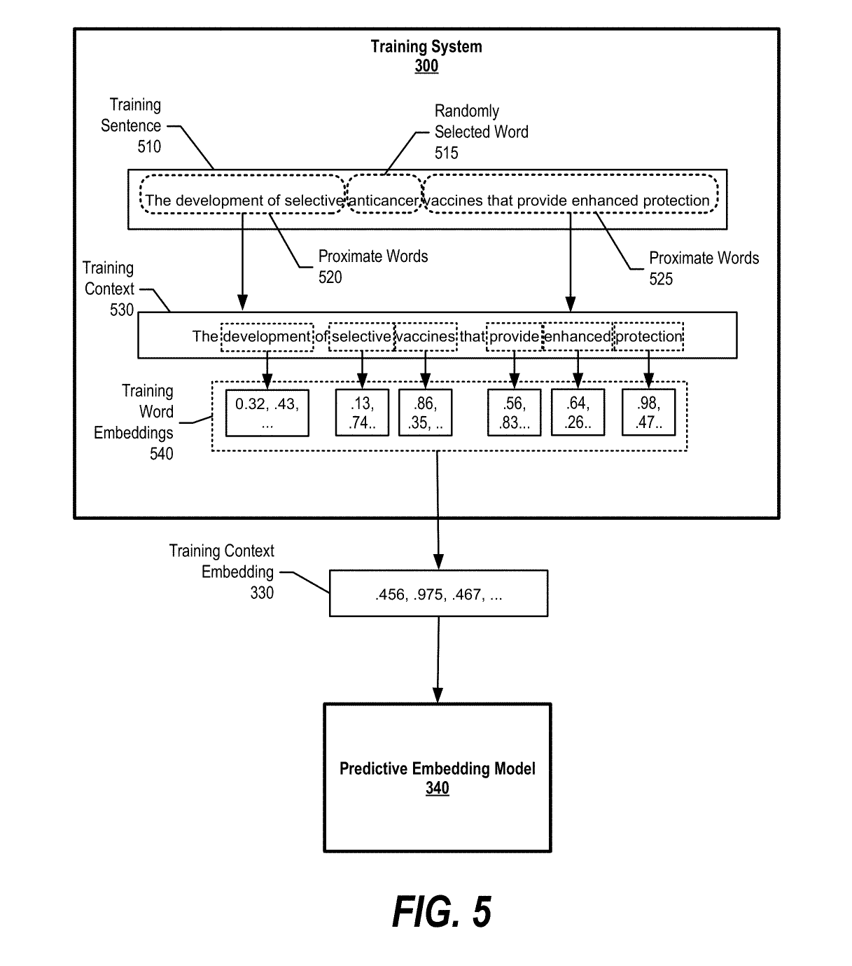

Training system 300 then uses documents in training corpus 310 to commence training predictive embedding model 340. Training system 300 randomly selects a word in training corpus 310 and builds a context of the word using words in proximity to the selected word, such as using three words to the left of the randomly selected word and three words to the right of the randomly selected word (see FIG. 5, proximate words 520 and 525).

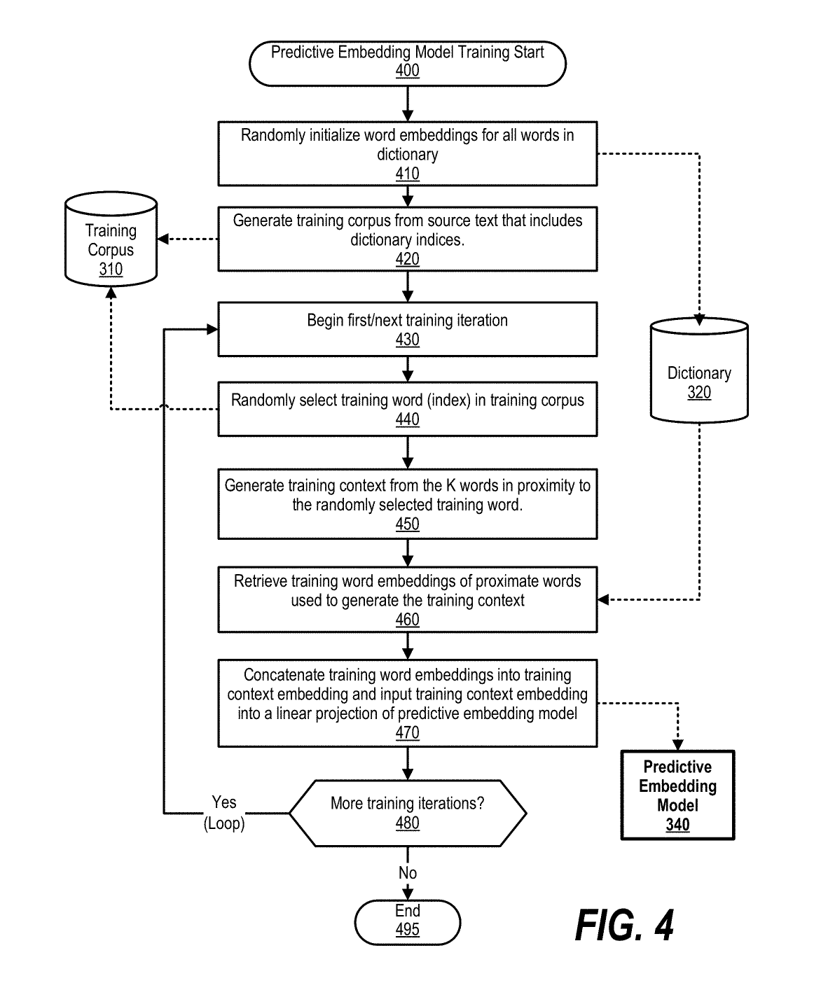

Training system 300 proceeds through a series of steps that transforms the context into one of training context embeddings 330 using word embeddings corresponding to the proximate words in the context (see FIGS. 4, 5, and corresponding text for further details). The training context embedding, in one embodiment, is used as the input into a linear projection of predictive embedding model 340. In this embodiment, the linear projection may be from 2*K*embeddingSize (the context) to embeddingSize (the embedding prediction). In this embodiment, the objective is a pairwise hinge loss where the goal is to make the prediction closer (in Euclidean distance) to the center word embedding relative to a word randomly selected from the dictionary.

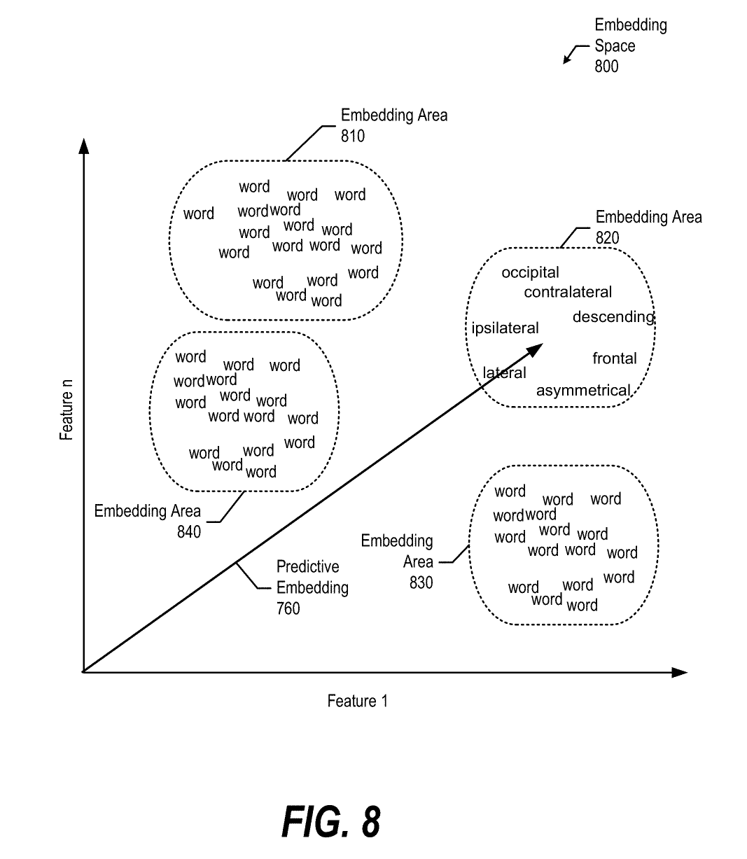

When predictive embedding model 340 is finished training, runtime system 360 is able to use predictive embedding model 340 to analyze an unknown word and generate a corresponding predictive embedding. As discussed herein, the predictive embedding, or predictive embedding vector, is a distributed numerical representation corresponding to features of the unknown word. For example, if an unknown word is actually a person's name, the predictive embedding will not point to “JOHN,” or “MARY,” but will point to the proximity of “naminess” feature sets in embedding space (see FIG. 8 and corresponding text for further details).

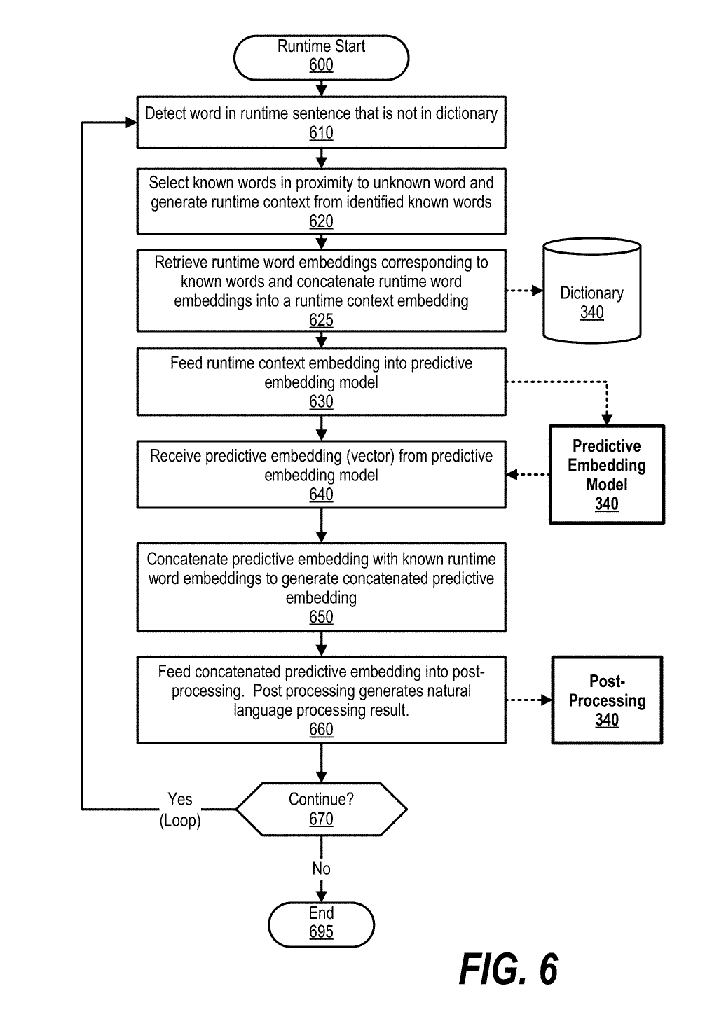

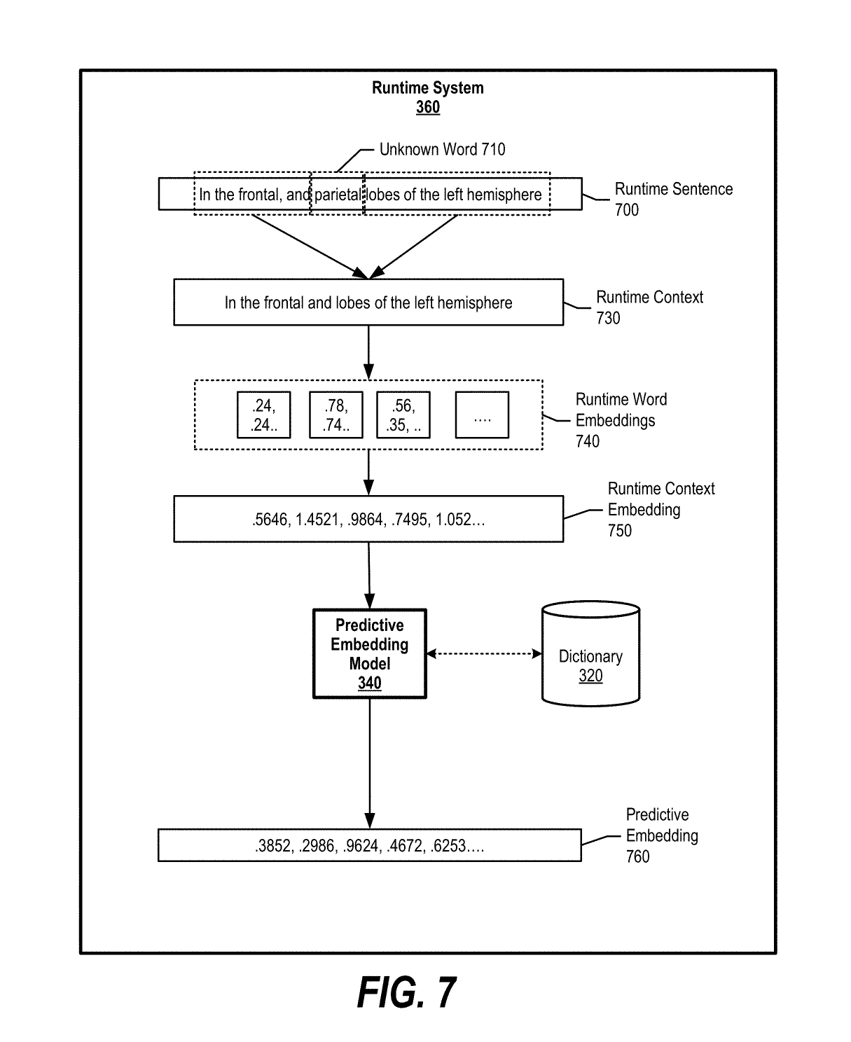

Referring to FIG. 3, runtime sentence 350 is “My name is ABCDEF.” Because “ABCDEF” is most likely not included in dictionary 320, runtime system 360 generates a runtime context embedding from a runtime context of known words in proximity to the unknown word and feed the runtime context embedding into predictive embedding model 340. Predictive embedding model 340, in turn, outputs a predictive embedding that corresponds to the feature set of the unknown word as discussed above (see FIGS. 6, 7, and corresponding text for further details).

Runtime system 360 then provides runtime embeddings 370 to post-processing 340, which include runtime word embeddings 375 (corresponding to known words in runtime sentence 350, and predictive embedding 380 corresponding to unknown word “ABCDEF.” In one embodiment, runtime system 360 concatenates runtime embeddings 370 into a concatenated predictive embedding and feeds the concatenated predictive embedding into post-processing 340. As discussed herein, post processing 340 generates natural language processing results using the predictive embedding, such as results generated from sentiment analysis, named entity recognition, and syntactic parsing.

FIG. 4 is a flowchart depicting steps take to train a predictive embedding model. FIG. 4 processing commences at 400 whereupon, at step 410, the process randomly initializes numeric word embeddings for words in dictionary 320. At step 420, the process generates a training corpus from source text that includes dictionary indices.

At step 430, the process begins a first training iteration and randomly selects a training word in training corpus 310 (step 440). In one embodiment, the words may be indexed and, in this embodiment, the process randomly selects an index instead of an actual word. At step 450, the process generates a training context from the “K” words in proximity to the randomly selected training word. Referring to FIG. 5, the process randomly selects word 515 and then uses proximate words 520 and 525 to generate training context 530, which describes the context of randomly selected word 515.

At step 460, the process retrieves numeric word embeddings from dictionary 320 of the proximate words included in the context. Referring to FIG. 5, training word embeddings 540 include a separate embedding (numeric vector) for each relevant word in training context 530.

Next, at step 470, the process concatenates the training word embeddings into a training context embedding and inputs the training context embedding into a linear projection of predictive embedding model 340. Referring to FIG. 5, the process generates training context embedding 330 from individual training word embeddings 540. In turn, predictive embedding model 340 trains on the training context embedding.

The process determines as to whether more training iterations are required (decision 480). For example, the process may be set to train predictive embedding model 340 on 1,000 training iterations. If more training iterations are required, then decision 480 branches to the ‘yes’ branch, which loops back to begin another training iteration by randomly selecting another word and proceeding through steps 450-470. This looping continues until no more training iterations are required, at which point decision 480 branches to the ‘no’ branch exiting the loop. FIG. 4 processing thereafter ends at 495.

FIG. 5 is a diagram showing a training sentence transformed to a training context embedding and input into a predictive embedding model for training.

Training system 300 retrieves training sentence 510 from training corpus 310 and randomly selects word 515, which is “anticancer.” Training system 300 selects proximate words 520 and 525 to build training context 530. In turn, training system 300 retrieves numeric word embeddings of the six words outlined in context 530, which are shown as training word embeddings 540. In turn, training system 300 concatenates training word embeddings 540 to generate training context embedding 330. Predictive embedding model 340 then uses training context embedding 330 on which to train, such as training its linear projection model. Once predictive embedding model 340 is trained, predictive embedding model 340 may be used to by a runtime system to generate predictive embeddings of unknown words (see FIGS. 6, 7, and corresponding text for further details).

FIG. 6 is a flowchart showing steps taken to generate a predictive embedding for an unknown word and using the predictive embedding in natural language post-processing tasks.

FIG. 6 processing commences at 600 whereupon, at step 610, the process detects a word in an input sentence that is not included in dictionary 340. At step 620, the process selects known words in proximity to the unknown word and generates a context from the selected known words. Referring to FIG. 7, the process detects unknown word 710 and generates runtime context 730 from known words surrounding unknown word 710.

At step 625, the process retrieves known embeddings corresponding to the known words in the context and concatenates the known embeddings into a runtime context embedding. At step 630, the process feeds the runtime context embedding into predictive model 340. Predictive embedding model 340 outputs a predictive embedding, based on the training of predictive embedding model 340, which corresponds to a distributed representation of the unknown word. Referring to FIG. 8, predictive embedding 760 points to embedding area 820 but does not point to a specific word in embedding space 800. At step 640, the process receives the predictive embedding from predictive embedding model 340 that corresponds to the unknown word.

The process, at step 650, in one embodiment, concatenates the predictive embedding with the runtime word embeddings from step 625 to create a concatenated predictive embedding.

At step 660, the process feeds the concatenated predictive embedding, or the runtime word embeddings with the predictive embedding, into post-processing 340 that, in turn, generates natural language processing results that correspond to the sentence using the predictive embedding or concatenated predictive embedding. For example, post-processing 340 may be a sentiment classifier that classifies the sentiment of the sentence or a syntactic parser that parses the sentence based on syntax.

A determination is made as to whether the process should continue (decision 670). If the process should continue, then decision 670 branches to the ‘yes’ branch which loops back to detect and process subsequent unknown words in sentences. This looping continues until the process should terminate, at which point decision 670 branches to the ‘no’ branch exiting the loop. FIG. 6 processing thereafter ends at 695.

FIG. 7 is a diagram depicting a runtime system generating a predictive embedding of an unknown word detected in a runtime sentence. Runtime system 360 receives runtime sentence 700, which may be a sentence from a source document that is being evaluated for sentiment. Runtime system 360 determines that word 710 is unknown (not included in dictionary 320). In turn, runtime system 360 generates runtime context 730 using words in proximity to unknown word 710.

Runtime system 360 retrieves runtime word embeddings 730 from dictionary 320 that correspond to each relevant word in runtime context 730 and concatenates runtime word embeddings 740 to generate runtime context embedding 750. In turn, predictive embedding model 340 receives runtime context embedding 750 and generates predictive embedding 760 based on its training. As discussed earlier, predictive embedding 380 is a distributed representation of the feature sets of unknown word 710. Referring to FIG. 8, predictive embedding 760 points to embedding area 820, which includes known words occipital, contralateral, descending, ipsilateral, lateral, asymmetrical, frontal, pontine, sagittal, and segmental. Therefore, although dictionary 320 does not include unknown word 710 “parietal,” predictive embedding 760 indicates that parietal is similar in meaning to occipital, contralateral, descending, ipsilateral, lateral, asymmetrical, frontal, pontine, sagittal, and segmental.

FIG. 8 is a diagram depicting an embedding space that maps feature sets of words based on their meanings. Embedding space 800 includes four “groupings” or “areas” of words, which are embedding areas 810, 820, 830, and 840. Each area includes a set of words having similar meanings (e.g., names, geographic locations, actions, etc.). During runtime processing, predictive embedding model 340 generates predictive embeddings based on an inputted runtime context embedding. As discussed in FIG. 7, predictive embedding model 340 generated predictive embedding 760 based on runtime context embedding 750. Post-processing 340, therefore, is able to more effective analyze runtime sentence 700 using predictive embedding 760 because predictive embedding 760 corresponds to a relative description of unknown word 710 instead of ignoring unknown word 710 altogether.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
generating a context embedding corresponding to a plurality of known words in a sentence that are in proximity to an unknown word in the sentence;
creating a predictive embedding corresponding to the unknown word based on the context embedding, wherein the predictive embedding corresponds to an embedding area of the unknown word without specifying the unknown word; and
utilizing the predictive embedding to generate one or more natural language processing results corresponding to the sentence.

2. The method of claim 1 wherein the generation of the context embedding further comprises:
detecting the unknown word in the sentence;
creating a context from the plurality of known words;
concatenating a plurality of word embeddings corresponding to the plurality of known words, the concatenating resulting in the context embedding.

3. The method of claim 1 wherein the creating of the predictive embedding is performed by a predictive embedding model and, prior to the creating of the predictive embedding, the method further comprises:
training the predictive embedding model using a training sentence that includes a plurality of training words, wherein the training further comprises:
randomly selecting one of the plurality of training words;
generating a training context using a set of the plurality of training words in proximity to the randomly selected training word;
generating a training context embedding corresponding to the training context using a set of training word embeddings corresponding to the set training words included in the training context; and
training the predictive embedding model using the training context embedding.

4. The method of claim 1 wherein the predictive embedding is a predictive embedding vector comprising a plurality of numeric coordinates, and wherein each of the plurality of numeric coordinates corresponds to at least one of a plurality of features of the unknown word.

5. The method of claim 4 wherein the predictive embedding vector points to the embedding area that comprises a plurality of similar words that are similar in meaning to the unknown word, and wherein the embedding area fails to include the unknown word.

6. The method of claim 1 further comprising:
concatenating the predictive embedding with a plurality of word embeddings corresponding to the plurality of known words in the sentence, resulting in a concatenated predictive embedding; and
utilizing the concatenated predictive embedding in the generation of the one or more natural language processing results.

7. The method of claim 1 wherein at least one of the one or more natural language processing results is based upon a post-processing task selected from the group consisting of a sentiment analysis task, a syntactic parsing task, and a named entity recognition task.

8. An information handling system comprising:
one or more processors;
a memory coupled to at least one of the processors; and
a set of computer program instructions stored in the memory and executed by at least one of the processors in order to perform actions of:
generating a context embedding corresponding to a plurality of known words in a sentence that are in proximity to an unknown word in the sentence;
creating a predictive embedding corresponding to the unknown word based on the context embedding, wherein the predictive embedding corresponds to an embedding area of the unknown word without specifying the unknown word; and
utilizing the predictive embedding to generate one or more natural language processing results corresponding to the sentence.

9. The information handling system of claim 8 wherein at least one of the one or more processors perform additional actions comprising:
detecting the unknown word in the sentence;
creating a context from the plurality of known words;
concatenating a plurality of word embeddings corresponding to the plurality of known words, the concatenating resulting in the context embedding.

10. The information handling system of claim 8 wherein the creating of the predictive embedding is performed by a predictive embedding model and, prior to the creating of the predictive embedding, and wherein at least one of the one or more processors perform additional actions comprising:
training the predictive embedding model using a training sentence that includes a plurality of training words, wherein the training further comprises:
randomly selecting one of the plurality of training words;
generating a training context using a set of the plurality of training words in proximity to the randomly selected training word;
generating a training context embedding corresponding to the training context using a set of training word embeddings corresponding to the set training words included in the training context; and
training the predictive embedding model using the training context embedding.

11. The information handling system of claim 8 wherein the predictive embedding is a predictive embedding vector comprising a plurality of numeric coordinates, and wherein each of the plurality of numeric coordinates corresponds to at least one of a plurality of features of the unknown word.

12. The information handling system of claim 11 wherein the predictive embedding vector points to the embedding area that comprises a plurality of similar words that are similar in meaning to the unknown word, and wherein the embedding area fails to include the unknown word.

13. The information handling system of claim 8 wherein at least one of the one or more processors perform additional actions comprising:
concatenating the predictive embedding with a plurality of word embeddings corresponding to the plurality of known words in the sentence, resulting in a concatenated predictive embedding; and
utilizing the concatenated predictive embedding in the generation of the one or more natural language processing results.

14. The information handling system of claim 8 wherein at least one of the one or more natural language processing results is based upon a post-processing task selected from the group consisting of a sentiment analysis task, a syntactic parsing task, and a named entity recognition task.

15. A computer program product stored in a computer readable storage medium, comprising computer program code that, when executed by an information handling system, causes the information handling system to perform actions comprising:
generating a context embedding corresponding to a plurality of known words in a sentence that are in proximity to an unknown word in the sentence;
creating a predictive embedding corresponding to the unknown word based on the context embedding, wherein the predictive embedding corresponds to an embedding area of the unknown word without specifying the unknown word; and
utilizing the predictive embedding to generate one or more natural language processing results corresponding to the sentence.

16. The computer program product of claim 15 wherein the information handling system performs additional actions comprising:
detecting the unknown word in the sentence;
creating a context from the plurality of known words;
concatenating a plurality of word embeddings corresponding to the plurality of known words, the concatenating resulting in the context embedding.

17. The computer program product of claim 15 wherein the creating of the predictive embedding is performed by a predictive embedding model and, prior to the creating of the predictive embedding, and wherein the information handling system performs additional actions comprising:
training the predictive embedding model using a training sentence that includes a plurality of training words, wherein the training further comprises:
randomly selecting one of the plurality of training words;
generating a training context using a set of the plurality of training words in proximity to the randomly selected training word;
generating a training context embedding corresponding to the training context using a set of training word embeddings corresponding to the set training words included in the training context; and
training the predictive embedding model using the training context embedding.

18. The computer program product of claim 15 wherein the predictive embedding is a predictive embedding vector comprising a plurality of numeric coordinates, and wherein each of the plurality of numeric coordinates corresponds to at least one of a plurality of features of the unknown word.

19. The computer program product of claim 18 wherein the predictive embedding vector points to the embedding area that comprises a plurality of similar words that are similar in meaning to the unknown word, and wherein the embedding area fails to include the unknown word.

20. The computer program product of claim 15 wherein the information handling system performs additional actions comprising:
concatenating the predictive embedding with a plurality of word embeddings corresponding to the plurality of known words in the sentence, resulting in a concatenated predictive embedding; and
utilizing the concatenated predictive embedding in the generation of the one or more natural language processing results.
